(19) United States
(12) Patent Application Publication
(10) Pub. No.: US 2016/0172635 A1
(43) Pub. Date: Jun. 16, 2016

(54) Battery Cell having a Prismatic or Cylindrical Housing, Battery Module and Motor Vehicle

(71) Applicants: ROBERT BOSCH GMBH, Stuttgart (DE); SAMSUNG SDI CO., LTD., Yongin-si, Gyeonggi-do (KR)

(72) Inventors: Frank STIMM, Leonberg (DE); Michael STEIL, Korntal-Muenchingen (DE); Alfons DOERR, Stuttgart (DE); Andreas BOSCH, Oberriexingen (DE)

(21) Appl. No.: 14/904,196

(22) PCT Filed: May 22, 2014
(86) PCT No.: PCT/EP2014/060495

§ 371 Date: Jan. 11, 2016

(30) Foreign Application Priority Data
Jul. 11, 2013 (DE) 10 2013 213 550.5

(51) Int. Cl. H01M 2/02; H01M 10/48; H01M 10/0525

(52) U.S. Cl. CPC H01M 2/024; H01M 10/0525; H01M 10/486; H01M 2220/20

(57) ABSTRACT

A battery cell, preferably a lithium ion battery cell, includes a prismatic or cylindrical housing with two opposite sides. The first side of the two opposite sides of the housing is partially or completely at cathode potential. The second side of the two opposite sides of the housing is partially or completely at anode potential. One of the two opposite sides additionally has a circumferential edge protruding partially or completely from the surface, while the other of the two opposite sides has a circumferential edge that is partially or completely recessed relative to the surface. The battery cell can be easily joined to other battery cells by stacking to form battery modules, making it possible to avoid expensive connecting techniques and production processes. The battery cell is included in a battery module and a motor vehicle that has an electric drive motor and a battery system.

The present invention relates to a battery cell, preferably a lithium-ion battery cell, having a prismatic or cylindrical housing, and to a battery module and a motor vehicle.

### PRIOR ART

For hybrid electric vehicles (HEV) and electric vehicles (EV), lithium-ion battery systems are preferred for use as traction batteries, owing to their relatively high specific energy density, low self-discharge and absence of a memory effect.

In order to achieve the power data and energy data required for operating the drive motor, a multiplicity of individual battery cells, the voltage of each being only approximately 4 V, are connected in series, or also in parallel, such that a total battery-pack voltage of over 450 V can be obtained.

The battery cells are usually prismatic, cylindrical or so-called pouch secondary cells (also called coffee-bag cells).

A conventional prismatic battery cell according to the prior art is shown in FIG. 1. The cell 10 has a rectangular, or prismatic, housing 11, which has two connecting terminals 12, 13 and an air vent 14 on one side. The usual component parts of a battery cell—not visible here—are arranged in the interior of the housing 11.

The construction of the battery cells to form a battery is usually effected according to a hierarchical structure, in which battery cells are first combined to form a module, and two or more modules form a sub-unit. Two or more sub-units then, in turn, form the battery (battery pack), it also being possible for the battery (battery pack) to be formed by two or more modules.

The interconnection of the cells by means of cell connectors is labor-intensive. Moreover, the cell connectors must be mechanically robust and resistant to corrosion, and they must have good conductivity and be elastic, since the cells undergo mechanical expansion and contraction during charging and discharging. Usually, cell, module and sub-unit contact connections are effected by screw connection or by welding. Connections by means of clinching or quick-coupling elements are also known. These connections involve a complex and cost-intensive production process.

In order to avoid the use of cell connectors, DE 10 2009 011 524 A1 discloses batteries in which current collectors are arranged on the narrow sides of prismatic cells in such a manner that these current collectors are already connected to each other in series by stacking of the cells.

### DISCLOSURE OF THE INVENTION

According to the invention, a battery cell, preferably a lithium-ion battery cell, is provided, which has a prismatic or cylindrical housing, wherein one side of two opposing sides of the housing is partially or completely at cathode potential, and the second side of the two opposing sides of the housing is partially or completely at anode potential, and one of the two sides has a circumferential edge projecting completely or partially from the surface, while the opposite side has a circumferential edge that is completely or partially recessed relative to the surface.

A battery cell, in the context of the invention, is understood to mean a rechargeable accumulator cell (secondary cell).

The edge projecting from the surface is designed so as to correspond to the edge on the opposite side, such that, when at least two battery cells are stacked, in the manner of a Lego brick, these edges engage in each other and the battery cells are thus fixed in their position in relation to each other.

The interconnection of the battery cells is therefore effected in a simple manner, by stacking the battery cells, since the corresponding surfaces, at anode or cathode potential, can thus be brought into contact with each other.

The projecting edge and the recessed edge in this case can be dimensioned in such a manner that a clamping connection is achieved between the two battery cells.

According to the invention, the projecting edge need not project all the way round the circumference. It is also possible for the latter to be discontinuous and, for example in the case of prismatic cells, to be provided only in the corner region. The recessed edge may correspondingly be formed-on in such a manner only in sub-portions, but a partially projecting edge can in any case be combined with a fully recessed edge.

Advantageously, with the battery cell designed according to the invention, it is possible to avoid the use of cell connectors in the interconnection of battery cells in series, such that, as a result of reduction of the passive materials, the energy density of the cell is also increased.

Moreover, the battery cells according to the invention reduce the amount of assembly work required, such that, as also a consequence of the reduction of components, it is possible to achieve a reduction of costs.

The parts of the housing at differing potential are electrically separated from each other by an insulator, for example in the form of a plastic part, or in another suitable manner.

Preferably, the surfaces having the greatest surface area are selected as opposing sides having differing potential, in order to achieve a cell stack that is as space-saving as possible.

The regions of the housing that are at anode or cathode potential constitute the connecting terminals, and are in each case located between the said edges and have as large a surface area as possible, in order to minimize the transfer resistance. However, these regions need not be identical in size.

Preferably, the connecting terminals are of a raised design, in order to achieve good contacting. In the case of the battery cells being strung together, a means for optimizing the contacting, such as a contact pad, a contact paste or a soft metallic foil, is preferably arranged between the cells.

According to a preferred embodiment of the invention, for the purpose of terminating a cell stack, composed of at least two battery cells, that constitutes a battery module, adapter pieces that enable contacting to at least one further battery module are arranged on the first and the last battery cell.

These adapter pieces may be shaped like a battery cell according to the invention, with the difference that the outer connecting terminals are designed for connection to conventional connectors.

It is also possible for the adapter pieces to be provided with two surfaces, which have a projecting edge or a recessed edge, these surfaces being arranged next to each other and being at the same potential. Battery-cell stacks that are arranged next to each other can thus be interconnected with each other, by using an adapter on one side.

Furthermore, a tap-off for voltage measurement is preferably provided for each voltage level. This means that an electrical contact, which is routed, for example, through the discontinuous edge or a separate channel, is connected to a module controller for the purpose of voltage measurement.

In addition, temperature sensors may be attached on a part of the surface of the cell housing that is encapsulated by two adjacent cells. The contacting of these temperature sensors is effected in the same manner as for the voltage measurement previously described.

In order to realize a module in the form of at least two battery cells that is likewise subject to loading, the battery cells are usually tensioned with each other, in order to prevent expansion of the battery cells. In this case, according to the invention, the adapter pieces are used as pressure plates, which are preferably arranged at both ends of a cell stack.

The invention greatly simplifies the process of combining cells to form modules and/or to form a battery pack, defective cells advantageously being replaced individually, such that there is a significant saving in costs in comparison with structures having non-separable connectors, since in the case of the latter it is always necessary to replace the entire module.

This design of a battery cell, or of the housing of a battery cell, according to the invention results in a saving in costs, owing to the absence of expensive connection techniques and production processes, such as individual screw connection of cell connectors or welding of the cell connectors, a significantly increased mechanical stability in comparison with hitherto known connection methods, and lesser transfer resistances between the cells. Owing to the lesser power loss at the transition from one cell to another, and an associated lesser heat generation, the battery modules according to the invention are able to achieve higher outputs, compared with modules according to the prior art.

In comparison with battery modules of conventional design, the risk of a contact loss is greatly reduced, such that safety is greatly increased with use of the battery cells according to the invention. Broken or loose cell connectors of the conventional design can cause, for example, arcing, with all known negative consequences.

The embodiments hitherto relate equally to battery cells and battery modules.

The components usually provided in the case of a battery cell that are not relevant for description of the invention are not mentioned explicitly.

The battery cell according to the invention and the corresponding battery module can be used in all traction battery systems, in particular in lithium battery systems for vehicles. Use in energy storage systems for energy networks/supply networks is likewise possible.

The present invention additionally relates to a motor vehicle, having an electric drive motor for driving the motor vehicle, and to a battery, which is connected or connectable to the electric drive motor and which has battery cells or modules according to the invention.

Advantageous developments of the invention are specified in the dependent claims and described in the description.

### DRAWINGS

Exemplary embodiments of the invention are explained more fully on the basis of the drawings and the description that follows. There are shown in:

FIG. 1, a battery cell according to the prior art, in a perspective view, and

FIG. 2, a battery cell according to the invention, in a side view.

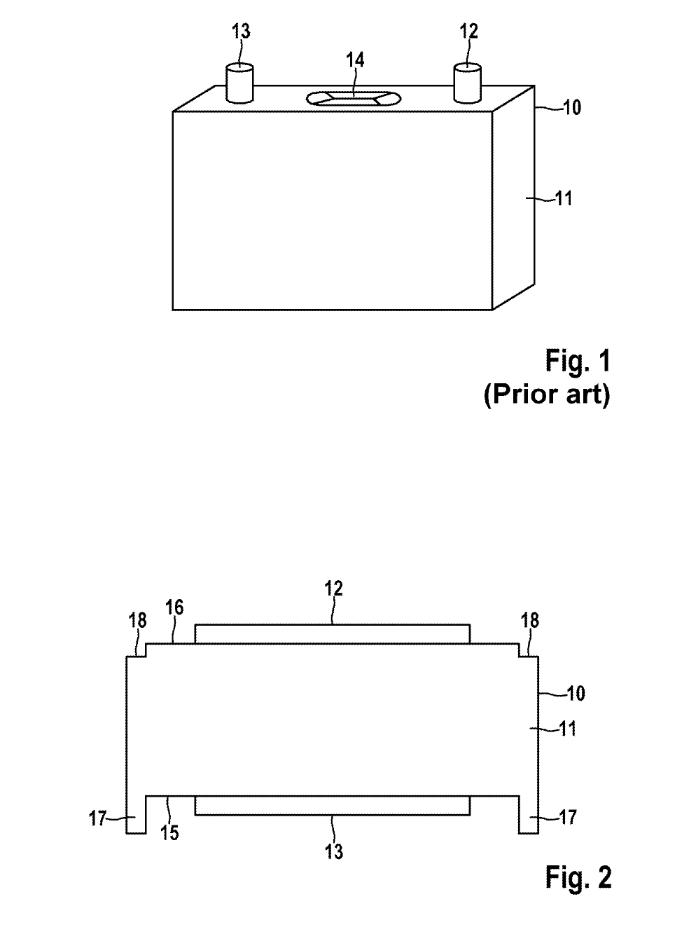

In the case of the battery cell 10 according to the invention, which is shown in FIG. 2, there is a connecting terminal 12, 13 of a raised design arranged, respectively, on one side 15 and on the opposite side 16 of the housing 11.

The one side 15 has a circumferential edge 17 projecting from the surface, while the opposite side 16 has a circumferential edge 18 that is recessed relative to the surface.

1. A battery cell, comprising:
a prismatic or cylindrical housing, characterized in that having two opposing sides, wherein:
one side of the two opposing sides of the housing is partially or completely at cathode potential, and the second side of the two opposing sides of the housing is partially or completely at anode potential, and
one of the two opposing sides has a circumferential edge projecting completely or partially from the surface, while the opposite side has a circumferential edge that is completely or partially recessed relative to the surface.

2. The battery cell as claimed in claim 1, wherein portions of the housing at differing potential are electrically separated from each other by an insulator.

3. The battery cell as claimed in claim 1, wherein the battery cell is a lithium-ion battery cell.

4. A battery module, comprising:
at least two battery cells, the battery cells each including a prismatic or cylindrical housing having two opposing sides, wherein:
one side of the two opposing sides of the housing is partially or completely at cathode potential, and the second side of the two opposing sides of the housing is partially or completely at anode potential,
one of the two opposing sides has a circumferential edge projecting completely or partially from the surface, while the opposite side has a circumferential edge that is completely or partially recessed relative to the surface, and
the battery cells form a battery-cell stack.

5. The battery module as claimed in claim 4, further comprising an element arranged between the battery cells and configured to optimize the contacting.

6. The battery module as claimed in claim 4, further comprising adapter pieces arranged at both ends of the battery-cell stack on the last battery cell in each case, the adapter pieces each having a contact configured to connect to at least one further battery module.

7. The battery module as claimed in claim 4, further comprising one or more of at least one electrical contact and at least one temperature sensor attached on a portion of the surface of the cell housing that is encapsulated by two adjacent cells.

8. A motor vehicle, comprising:
an electric drive motor configured to drive the motor vehicle, and
a battery system configured to be connected to the electric drive motor, the battery system including:
a plurality of battery cells with each battery cell including a prismatic or cylindrical housing having two opposing sides, wherein:
one side of the two opposing sides of the housing is partially or completely at cathode potential, and the second side of the two opposing sides of the housing is partially or completely at anode potential, and
one of the two opposing sides has a circumferential edge projecting completely or partially from the surface, while the opposite side has a circumferential edge that is completely or partially recessed relative to the surface, or
a plurality of battery modules with each battery module including at least two battery cells, the battery cells each including a prismatic or cylindrical housing having two opposing sides, wherein:
one side of the two opposing sides of the housing is partially or completely at cathode potential, and the second side of the two opposing sides of the housing is partially or completely at anode potential,
one of the two opposing sides has a circumferential edge projecting completely or partially from the surface, while the opposite side has a circumferential edge that is completely or partially recessed relative to the surface, and
the battery cells form a battery-cell stack.
